(19) United States
(12) Patent Application Publication
(10) Pub. No.: US 2003/0226432 A1
(43) Pub. Date: Dec. 11, 2003

(54) Gang saw system for rotating and segmenting a workpiece

(76) Inventor: Mark J. Majeski, Norton, WV (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/163,864

(22) Filed: Jun. 5, 2002

(51) Int. Cl. B26D 7/06

(52) U.S. Cl. 83/13; 83/425

(57) ABSTRACT

An apparatus for manufacturing a plurality of cores from a workpiece. In one embodiment, the apparatus includes a support structure for supporting the workpiece. A cutting assembly includes an arbor with a plurality of cutting blades spaced equidistant apart. Either one, or both, of the support structure and the cutting assembly may be move toward the other such that the cutting assembly engages the workpiece. As the cutting assembly engages the workpiece to cut the workpiece, the workpiece is rotated so that the blades of the cutting assembly cut the workpiece into the plurality of cores.

### RELATED APPLICATIONS

The application titled “CORE FOR WINDING MATERIAL AND METHOD FOR MANUFACTURING THE SAME”, having been filed concurrently with the present application, is hereby incorporated herein by reference.

### TECHNICAL FIELD

The present invention relates to the introduction of a workpiece to a saw and, more particularly, relates to segmenting the workpiece into a plurality of portions, to be used as cores, upon which materials may be wound.

### BACKGROUND OF THE INVENTION

The use of a core is widely used in many industries for the winding and unwinding of materials. A goal in each industry is to utilize a cost effective core in the manufacturing process. Also, each industry desires to utilize a core which has structural characteristics suitable for the particular material to be wound or unwound. Some materials require that the core, upon which it is wound, to have particular dimensional requirements as well as strength requirements. Moreover, some industries require that their cores not only be reusable, but be manufactured from readily available materials for cost effectiveness.

For example, aluminum producers typically require aluminum of a particular gauge and width be wound on a cardboard core. Although cardboard is cost effective to use, problems often occur which degrade the structural integrity of cardboard cores. One such problem is that cardboard cores are prone to shrinkage as a result of the changing moisture content in the cores. Another problem is that cardboard cores sometimes collapse because of insufficient strength. In response, some industries have attempted to utilize machined steel cores; but this is cost prohibitive. Moreover, the use of steel cores does not provided the desired dimensional requirements needed in most industries that utilizing some sort of winding or unwinding apparatus.

The cores upon which most materials are wound are typically circular with a hollow interior. Some industries require that the width and inner diameter of these cores have a particular dimension in order for the cores to be suitable for use with their winding or unwinding machines. However, manufacturing a core having the desired inner diameter, while utilizing readily available and cost effective materials, has proven difficult.

PVC (polyvinyl chloride) or some other thermoplastic resin, for example, is readily available and cost effective to use. Also, the structural integrity of the PVC is what is desired by the industry. However, PVC is typically manufactured in the form of elongated pipe having a substantial length. Thus, workpieces having a substantial length are often difficult to work with. Once the length of the PVC workpiece is cut to form a core of a particular width, the diameter of the core may be more easily resized into the desired configuration for use as a core. It is the dimensioning characteristic that makes PVC desirable to use.

Therefore, there is a need for a gang saw for cutting a readily available and cost effective workpiece, such as an elongated piece of PVC, into a plurality of cores. The saw must be able to receive and cut the workpiece into a plurality of portions having a particular configuration so that the cores may then be more easily resized, if desired, in a fast and cost effective manner.

### SUMMARY OF THE INVENTION

The present invention solves the above-identified problem by providing a gang saw system for orienting and segmenting a workpiece. The workpiece is oriented in the gang saw system to facilitate the workpiece being segmented into cores.

Generally described, the present invention includes a support structure for supporting the workpiece relative a cutting assembly. In one embodiment, the cutting assembly includes an arbor having a plurality of spaced apart cutting blades. The workpiece is selectively moved toward the cutting assembly until the blades of the cutting assembly engage the workpiece. Alternatively, the cutting assembly is selectively moved toward the workpiece until the blades of the cutting assembly engage the workpiece.

According to one aspect of the invention, the workpiece is oriented into the cutting assembly to segment the workpiece into a plurality of portions commonly referred to as cores. Preferably, the workpiece is rotated into the blades so that each of the blades makes a continuous cut all the way around the workpiece.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

### BRIEF DESCRIPTION OF THE DRAWINGS

FIG. 1 illustrates a front view of one embodiment of the gang saw system of the present invention.

FIG. 2 illustrates an end view of the gang saw system depicted in FIG. 1.

FIG. 3 illustrates a front view of a structure for translating the workpiece into the gang saw system of FIG. 1.

FIG. 4 illustrates a close-up perspective view of a portion of the present invention wherein a workpiece is supported between a plurality of elongated rollers.

FIG. 5 illustrates a close-up perspective view of the cutting assembly cutting the workpiece.

FIG. 6 illustrates a plurality of cores manufactured in accordance with the present invention.

### DETAILED DESCRIPTION

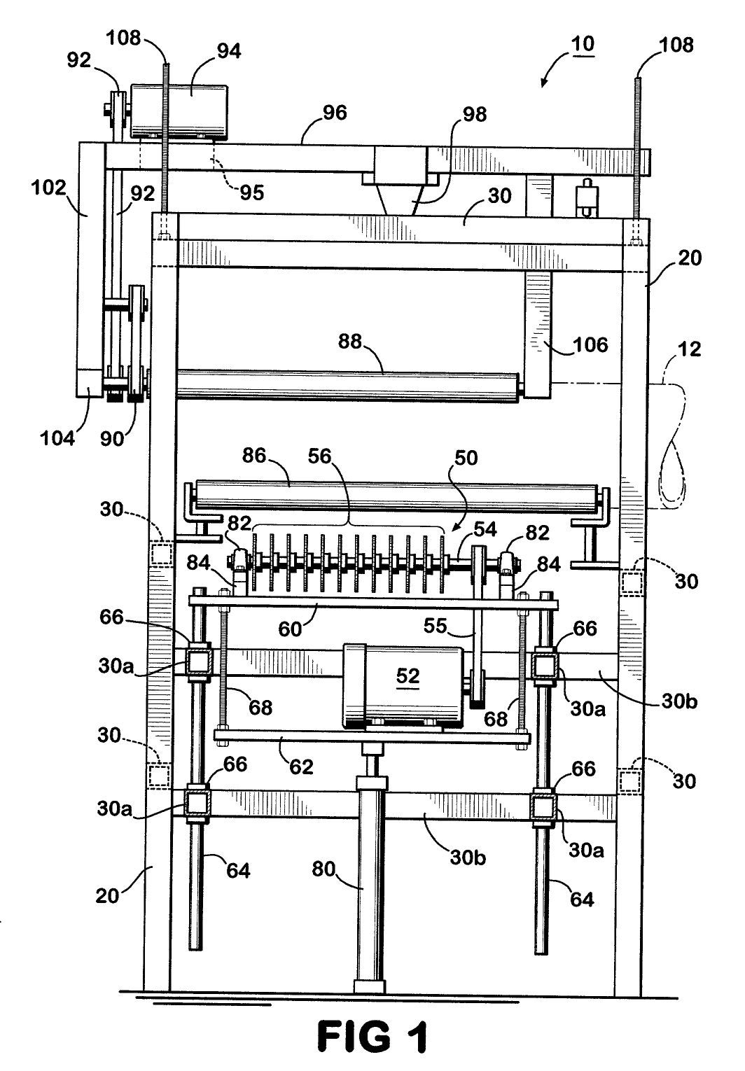

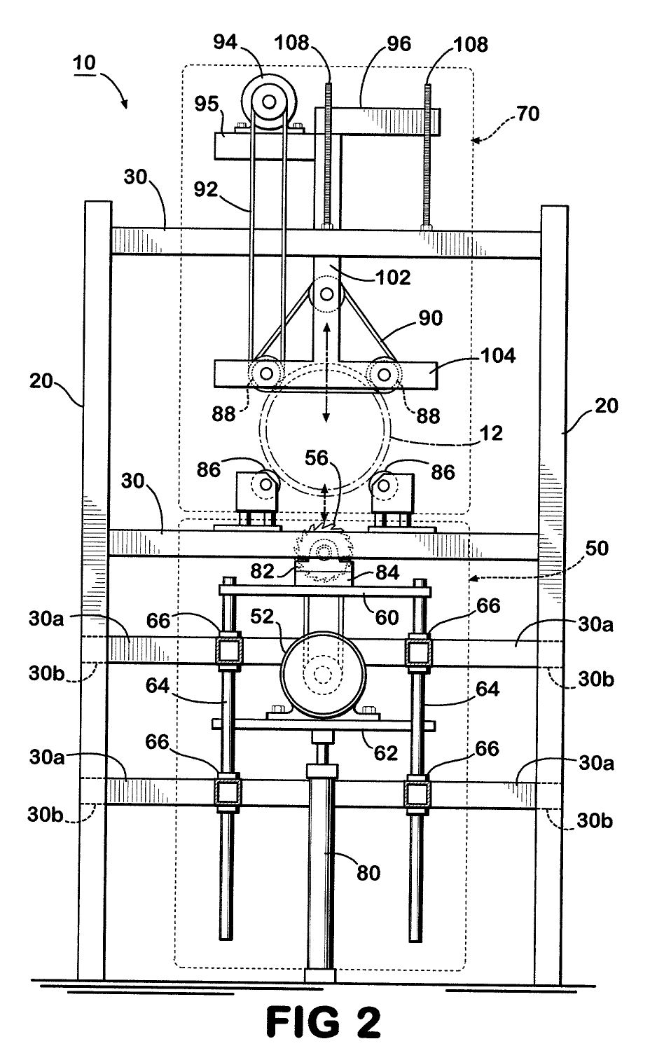

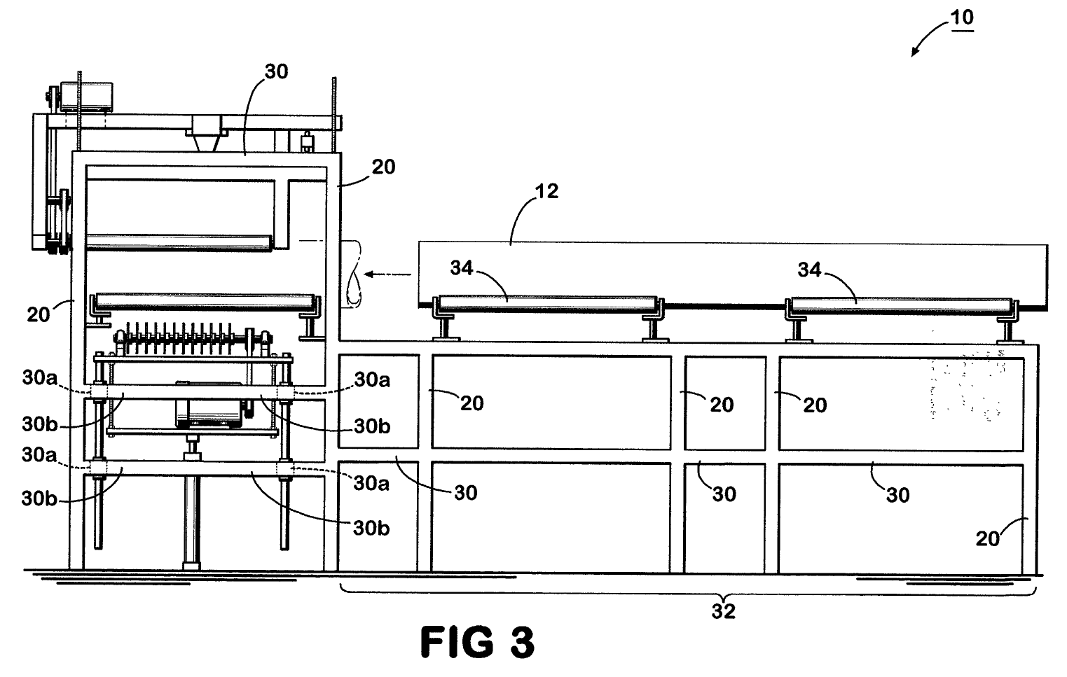

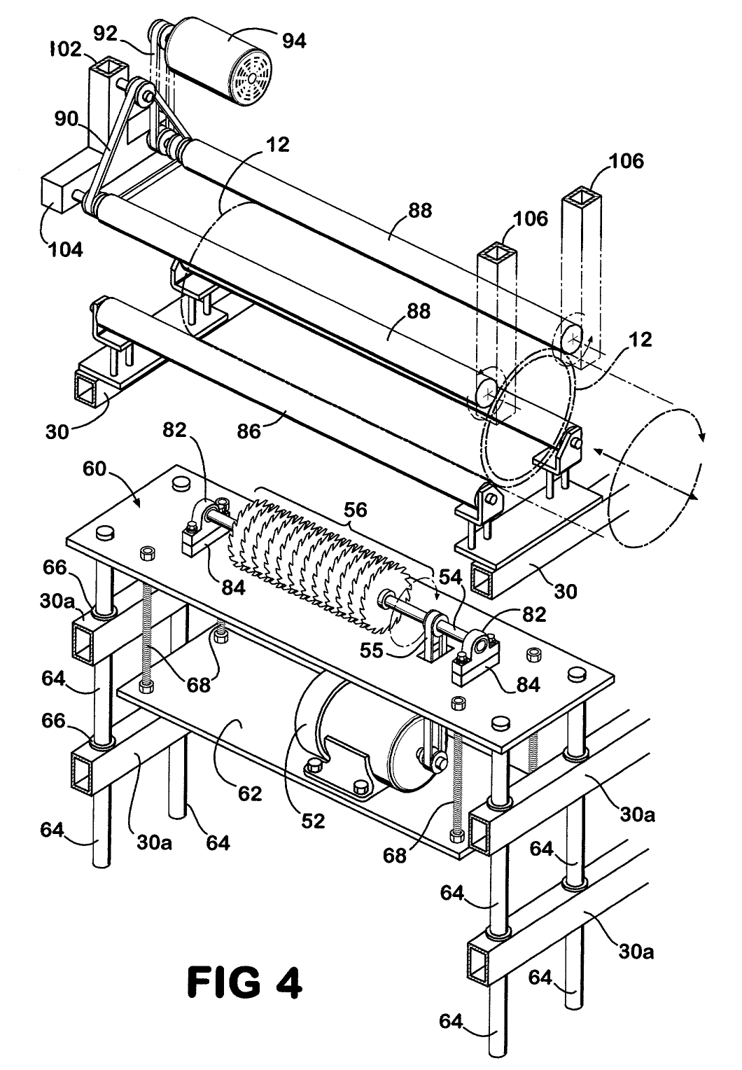

Referring now to the drawings in which like numerals indicate like elements throughout the several views, FIGS. 1 and 2 depict a gang saw system 10 for orienting and segmenting a workpiece 12 (FIGS. 3 and 4). The gang saw 10 includes a plurality of vertical members 20 and horizontal members 30 to define a structural framework with an interior space for supporting a cutting assembly 50 and a support structure 70 for handling the workpiece 12.

Although the embodiments described herein are primarily directed toward the use of a PVC workpiece, the present invention contemplates the use of workpieces of any type of material in an elongated form, as shown in FIG. 3, which may be segmented into cores for winding a continuous web of material. The workpiece 12 is typically cylindrical with a hollow center there through. Preferably, the workpiece 12 is hollow PVC piping. However, the workpiece 12 may have any possible configuration suitable for being segmented into a plurality of cores for receiving a continuous web of material.

While any suitable material may be used, the vertical and horizontal members 20, 30 are preferably steel two by two inch box tubing. However, angle iron may also be used to provide structural support. As best shown in FIGS. 1 and 2, the vertical members 20 are laterally spaced apart from one another and the horizontal members 30 are laterally spaced apart from one another to define the interior space. The vertical and horizontal members 20, 30 are secured together with mechanical fasteners. Alternatively, the vertical and horizontal members 20, 30 may be suitably welded or otherwise secured to each other to provide a rigid framework. The width and height of the structural framework is dependent upon the desired scope of movement from the cutting assembly 50 and the support structure 70, as described below.

Also, as shown in FIG. 3, the framework of the gang saw system 10 may be extended to include a table-like structure 32 for translating the workpiece 12 into the support structure 70. The table-like structure 32 is preferably also assembled from additional vertical and horizontal members 20, 30. Elongated free rollers 34 may also be included to keep the workpiece 12 properly aligned with the support structure 70. In this embodiment, the workpiece 12 is slid along the length of the rollers 34 when being translated into the support structure 70. The workpiece 12 is slid into the support structure 70 until the end of the workpiece 12 abuts a stop extending inward from the framework. Preferably, the stop is adjustable so that the extent which the workpiece 112 is received into the support structure 70 can be varied.

In the preferred embodiment, the support structure 70 is positioned over the cutting assembly 50 as shown in FIGS. 1 and 2. The cutting assembly 50 is preferably moveable toward the workpiece 12 held in the support structure 70 as shown in FIG. 4. However, the workpiece 12 may instead be moved toward the cutting assembly 50. In such case, the workpiece 12 would be lowered to be engaged by the cutting assembly 50. In another embodiment, both the cutting assembly 50 and the support structure 70 may be moved toward one another such that the workpiece 12 may be engaged by the cutting assembly 50.

The cutting assembly 50 includes a motor 52 for driving an arbor 54. Preferably the motor 52 is at least a three horsepower, rotational movement motor. A continuous belt 55 is placed between the motor 52 and the arbor 54. The arbor 54 includes a plurality of circular saw blades 56 which are spaced equidistant apart from one another as shown in FIG. 3. The type of blade 56 required depends on the type of workpiece 12. For example, diamond tipped blades are suitable for cutting PVC pipe.

The distance which each blade 56 is spaced from another adjacent blade 56 is dependent upon the width desired for each of the cores being manufactured. Preferably, the blades 56 are secured to the arbor 54 by collars 58. Holes (not shown) are drilled in blade 56 and a corresponding collar 58 in order to join each blade 56 with the corresponding collar 58. When the blades 56 with collars 58 are placed onto the arbor 54, set screws (not shown) are tightened to secure each blade 56 at a desired position along the length of the arbor 54.

The distance between each blade 56 on the arbor 54, and thus the width of each core being manufactured, may be adjusted by loosening the set screws and repositioning the blades 56 along the length of the arbor 54 so that the distance between each blade 56 corresponds to the desired width of the cores to be manufactured. Alternatively, in order to prevent having to repeatedly adjust the distance between adjacent blades 56 on a single arbor when manufacturing cores of different widths, the arbor 54 having the blades 56 set to cut cores having one particular width may be removed from the gang saw system 10 and replaced with another arbor 54 having blades 56 preset to manufacture cores having a different width. Each different arbor 54 with blades 56 is commonly referred to as a blade arrangement.

The cutting assembly 50 further includes upper and lower planar members 60 and 62 which are supported in the framework by guide rods 64 and linear bearings 66. The linear bearings 66 are secured to two pairs of opposing horizontal members 30a. Preferably the horizontal members 30a are wider two by three inch box tubing in order to accommodate the width of the linear bearings 66. FIG. 2 best illustrates one pair of upper and lower horizontal members 30a which obstruct the view of the opposing pair of upper and lower horizontal members 30a on the opposite side of the framework. The ends of the horizontal members 30a are secured between two pairs of opposing horizontal members 30b. FIG. 1 best illustrates one pair of upper and lower horizontal members 30b which obstruct the view of the opposing pair of upper and lower horizontal members 30b on the opposite side of the framework. The horizontal members 30a are positioned inward toward the center of the framework relative the exterior of the framework due to the narrower dimensions of the upper and lower planner members 60, 62 which must be able to move up and down within the framework.

The upper ends of the guide rods 64 extend downward from the bottom of the upper planar member 60. Each of the guide rods 64 pass through a pair of aligned linear bearings 66. The upper and lower planar members 60, 62 are secured to each other at their corners by threaded rods 68. As best shown in FIG. 1, the lower planar member 62 is suspended from the upper planner member 60 via threaded rods 68.

Between the lower planar member 60 and the floor upon which the gang saw system 10 sits is a screw jack 80. The screw jack 80 raises and lowers the upper and lower members 60, 62 as the guide rods 64 pass through the linear bearings 66. The motor 52 is secured to the top of the lower member 62 and is raised and lowered along with the lower planar member 62. The arbor 54 with blades 56 is secured upon the top of the upper member 60 with pillow blocks 82. A portion 84 of box tubing may be used between the upper planar member 60 and the pillow blocks 82 to obtain sufficient clearance between the blades 56 and the upper planar member 60. Thus, as the screw jack 80 raises the upper and lower planar members 60, 62, the blades 56 are placed into contact with the workpiece in order to cut the workpiece. The blades 56 of the cutting assembly 50 may begin to rotate to cut the workpiece 12 before the blades 56 engage the workpiece 12 or, alternatively, the blades 56 may begin to rotate after they engage the workpiece 12.

When the workpiece 12 is received in the support structure 70, as best illustrated in FIG. 4, the workpiece 12 rests on top of a pair of elongated free rollers 86. Note that the free rollers 86 are rotatably fixed to the framework in FIGS. 1, 2 and 4. Because the free rollers 86 are fixed to the framework and the workpiece 12 on the rollers 86 does not get raised or lowered, the support structure 70 depicted in FIGS. 1, 2 and 4 is not considered to be selectively moveable.

Another pair of drive rollers 88 may be raised and lowered into contact with the workpiece 12 as the workpiece 12 rests on top of free rollers 86. Because the drive rollers 88 are moveable relative to free rollers 86, workpieces 12 with different diameters may be easily accommodated. A continuous belt 90 extends between the drive rollers 88 which are in turn driven by continuous belt 92 and motor 94. The motor 94 sits on top of extension member 95 which extends laterally from member 96 in order to allow belt 92 to extend downward unobstructed.

Underneath member 96 is a scissors lift 98 which is used to raise and lower member 96. The scissors lift 98 sits on top of one of the uppermost horizontal members 30. In FIGS. 1 and 2, the scissors lift 98 is fully extended. Extending downward from the end of member 96 is vertically-oriented member 102 which is received to horizontal member 104. One end of each of the drive rollers 88 is secured to the horizontal member 104. The opposite end of each of the drive rollers 88 is secured to vertically-oriented member 106. The uppermost end of the vertically-oriented member 106 is then secured to member 96. Guide rods 108, which extend upward from the uppermost horizontal member 30 to extend through member 96, may be utilized to prevent swaying. The scissors lift 98 should be limited to up and down motion.

Alternatively, the rollers 86 may be fixed to an additional member which is also secured to the vertically-oriented member 102, similar to the manner horizontal member 104 is secured, so that the free rollers 86 may be raised and lowered by the scissors lift 98 in combination with drive rollers 88. In such case, the support structure 70, with the workpiece 12 therein, would be selectively movable toward the cutting assembly 50.

In operation, the horizontal member 30, upon which the scissors lift 98 rests, remains in a fixed position. As the scissors lift 98 lowers the member 96 downward, the drive rollers 88 are lowered down onto the workpiece 12. The workpiece 12 is then trapped between drive rollers 88 and free rollers 86. The workpiece 12 should not be permitted to move from side to side or flex in order to maintain certain width tolerances required of cores. The motor 94 then allows the drive rollers 88 to rotate the workpiece 12. The rotating blades 56 of the cutting assembly 50 are then raised to engage the rotating workpiece 12 and the workpiece is rotated into the rotating blades 56.

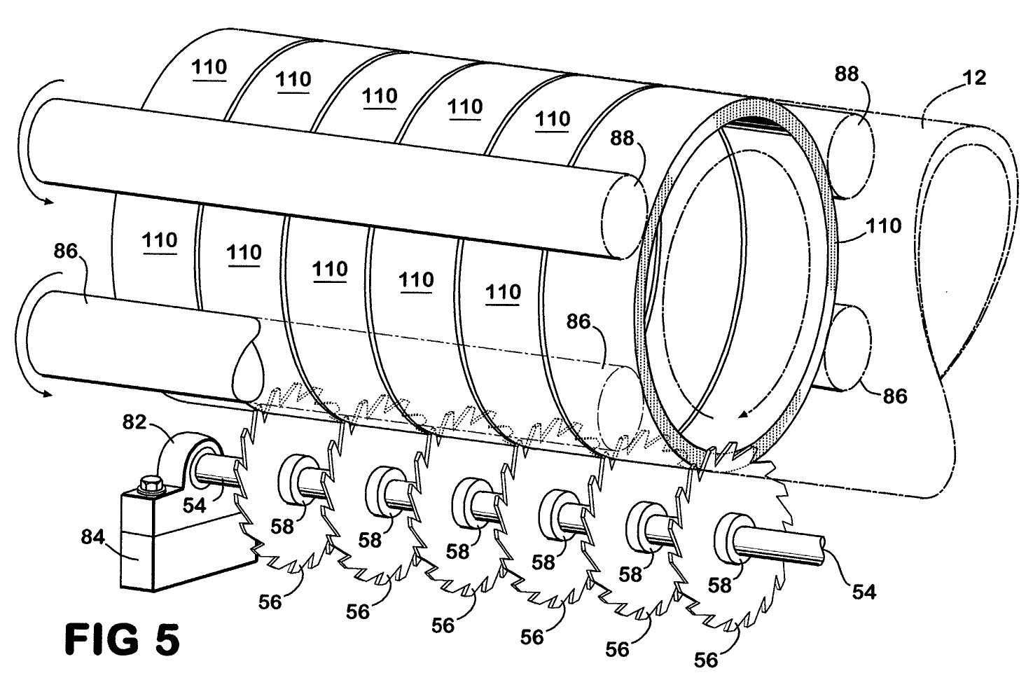

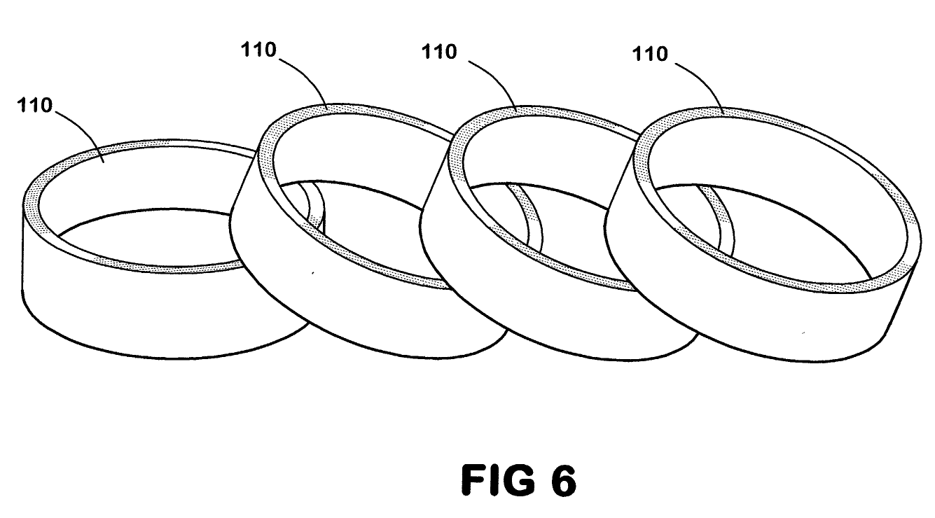

FIG. 5 best illustrates rotating blades 56 engaging and cutting into the rotating workpiece 12. The workpiece 12 is rotated more than one complete revolution in order to let each rotating blade 56 to simultaneously make a clean and continuous cut all the way around the periphery of the workpiece 12. The more times the workpiece 12 is rotated, the clearer the cuts made into the workpiece 12 are. However, in one embodiment, the workpiece 12 may be rotated only one complete revolution to cut all the way around the periphery of the workpiece 12. The multiple continuous cuts made into the workpiece 12 result in a plurality of cores 110 as shown in FIG. 6, which may then be used for winding a continuous web of material. Note that the portions of workpiece 12 between the cuts being made into the workpiece 12 remain free from contact from the blades 56.

The use of the gang saw 10 as described above constitutes an inventive method of the present invention in addition to the gang saw 10 itself. In practicing the method of manufacturing a plurality of cores from a workpiece 12, the steps include supporting the workpiece 12 relative a cutting assembly 50 as described above. The next step includes moving either the workpiece 12 in the support structure 70 or the cutting assembly 50 toward the other such that the cutting assembly 50 engages the workpiece 12. Alternatively, both the support structure 70 with the workpiece 12 and the cutting assembly 50 may be moved toward each other. Next, the method includes segmenting the workpiece 12 into a plurality of portions by orienting the workpiece 12 relative the cutting assembly 50. Preferably, the orienting step includes rotating the workpiece 12 into the cutting assembly 50 such that the cutting assembly 50 makes a plurality of separate and continuous cuts all the way around the workpiece 12.

The method of the present invention may also include the step of replacing the arbor 54 and blades 56 with a different arbor 54 and blades 56 so that different cores having different widths may be more easily manufactured.

The present invention has been illustrated in relation to particular embodiments which are intended in all respects to be illustrative rather than restrictive. Those skilled in the art will recognize that the present invention is capable of many modifications and variations without departing from the scope of the invention. Accordingly, the scope of the present invention is described by the claims appended hereto and supported by the foregoing.

What is claimed is:

1. An apparatus for manufacturing a plurality of cores from a workpiece, said apparatus comprising:
means for segmenting the workpiece into a plurality of portions; and
means for supporting the workpiece relative said segmenting means, at least one of said support means and said segmenting means being selectively movable toward the other, such that said segmenting means will engage the workpiece to segment the workpiece into portions.

2. The apparatus of claim 1 wherein said segmenting means is movable toward said supporting means.

3. The apparatus of claim 1 wherein said supporting means is movable toward said segmenting means.

4. The apparatus of claim 1 wherein both said supporting means and said segmenting means are each movable relative the other.

5. The apparatus of claim 1 wherein said support means orients the workpiece into the segmenting means while the segmenting means engages the workpiece.

6. The apparatus of claim 1 wherein said support means comprises means for at least partially orienting the workpiece into the segmenting means.

7. The apparatus of claim 6 wherein said means for at least partially orienting the workpiece rotates the workpiece relative said segmenting means.

8. The apparatus of claim 6 wherein said means for at least partially orienting the workpiece comprises at least one drive roller for contacting and rotating the workpiece relative said segmenting means.

9. The apparatus of claim 1 wherein the workpiece is rotated about a center axis while supported in said supporting means and while said segmenting means engages the workpiece.

10. The apparatus of claim 9 wherein the workpiece is rotated one complete revolution into said segmenting means.

11. The apparatus of claim 1 wherein said portions of the workpiece are similarly configured to one another.

12. The apparatus of claim 1 wherein said segmenting means substantially simultaneously segments the workpiece into a plurality of portions of the workpiece.

13. The apparatus of claim 1 wherein said segmenting means is a cutting assembly comprising a first arbor having a plurality of spaced apart circular saw blades.

14. The apparatus of claim 13 wherein said plurality of circular saw blades form a first blade arrangement having a predetermined distance between each said circular saw blade corresponding to a desired width of each said portion segmented from the workpiece.

15. The apparatus of claim 14 wherein said first blade arrangement is removed from said cutting assembly and replaced with a second blade arrangement, said second blade arrangement having circular saw blades spaced relative to each other a different predetermined distance relative the distance between said circular saw blades of said first blade arrangement.

16. The apparatus of claim 13 wherein the distance between each cut being made into the workpiece by said circular saw blades corresponds with the distance between each said circular saw blade, and each said portion of the workpiece between each cut being made into the workpiece remaining free from contact from said circular saw blades.

17. The apparatus of claim 13 wherein each said circular saw blade of said cutting assembly makes a continuous cut all the way around the workpiece.

18. The apparatus of claim 1 wherein said workpiece is an elongated hollow workpiece.

19. The apparatus of claim 18 wherein said elongated hollow workpiece is tubular.

20. The apparatus of claim 18 wherein said elongated hollow workpiece is PVC.

21. A method for manufacturing a plurality of cores from a workpiece, said method comprising the steps of:
supporting the workpiece relative a cutting assembly;
moving at least one of the workpiece and the cutting assembly toward the other such that the cutting assembly engages the workpiece;
cutting the workpiece into a plurality of portions; and
orienting the workpiece relative the cutting assembly while the cutting assembly cuts the workpiece.

22. The method of claim 21 wherein said orienting step comprises at least partially rotating the workpiece into the cutting assembly.

23. The method of claim 22 wherein said orienting step comprises rotating the workpiece at least one complete revolution into the cutting assembly such that the cutting assembly makes a plurality of separate and continuous cuts all the way around the workpiece.

24. The method of claim 21 wherein said orienting step comprises driving the workpiece with a drive roller such that the workpiece is rotated.

25. The method of claim 21 wherein the cutting assembly comprises a first arbor having a plurality of blades spaced a first distance apart from one another along the length of said first arbor, and wherein the method further comprises the steps of removing said first arbor and replacing said first arbor with a second arbor having a plurality of blades spaced a second distance apart from one another along the length of said second arbor.

26. The method of claim 21 wherein said cutting step comprises substantially simultaneously cutting the workpiece into a plurality of portions.

27. A plurality of portions of the workpiece manufactured in accordance with the method of claim 21.

28. An apparatus for manufacturing a plurality of cores from a workpiece, said apparatus comprising:
a cutting assembly for segmenting the workpiece into a plurality of portions; and
a support structure for supporting the workpiece relative said cutting assembly, at least one of said support structure and said cutting assembly being selectively movable toward the other, and said support structure operable to rotate the workpiece into the cutting assembly, such that said cutting assembly will engage the workpiece and segment the workpiece into portions.
